(19) United States
(12) Patent Application Publication
(10) Pub. No.: US 2022/0305828 A1
(43) Pub. Date: Sep. 29, 2022

(54) PRINTING APPARATUS AND MAINTENANCE METHOD THEREOF

(71) Applicant: SCREEN HOLDINGS CO., LTD., Kyoto (JP)

(72) Inventors: Kensuke Usui, Kyoto (JP); Susumu Takahashi, Kyoto (JP)

(21) Appl. No.: 17/666,856

(22) Filed: Feb. 8, 2022

(30) Foreign Application Priority Data
Mar. 24, 2021 (JP) 2021-049700

(51) Int. Cl. B41J 29/393; B41J 2/165

(52) U.S. Cl. CPC B41J 29/393; B41J 2/16526; B41J 2002/16529

(57) ABSTRACT

After printing based on each job is ended, a printing control unit controls an operation of a printing unit so that an inspection pattern is printed on a print sheet in a period during which a conveyance control unit is keeping a conveyance speed of a print sheet at a constant speed. A maintenance content determination unit determines a maintenance content for the printing unit on the basis of an inspection result obtained by inspecting a print image for the inspection pattern. The printing control unit controls operations of the printing unit and a cleaning mechanism depending on the maintenance content determined by the maintenance content determination unit.

### BACKGROUND OF THE INVENTION

### Field of the Invention

The present invention relates to a printing apparatus and a maintenance method thereof.

### Description of Related Art

Heretofore, there has been known an inkjet printing apparatus that performs printing by ejecting ink to a base material (a print medium) such as a print sheet. In the inkjet printing apparatus, when an ejection interval is lengthened, then in a period during which the printing is performed, there may occur drying of the ink due to evaporation of a solvent in the vicinity of a nozzle, mixing of air bubbles into the inside of the nozzle, adhesion of dust to the nozzle, or the like. When such a phenomenon occurs, normal ejection or the like cannot be performed, which may result in an occurrence of a printing failure. Accordingly, a maintenance for avoiding such a problem is performed occasionally.

The maintenance is roughly classified into: cleaning such as wiping (wiping off dirt) a nozzle surface of an inkjet head (a print head) by using a dedicated mechanism; and flushing of forcibly executing an ink ejection operation unrelated to a printed content. The flushing can be executed during conveyance of the print sheet, but the cleaning needs to be executed during stop of the conveyance of the print sheet. A technique of the flushing includes a variety of modes. There are known: star flushing (discrete flushing) of thinly ejecting ink to the whole of a page on which the printing is to be performed; line flushing of simultaneously ejecting ink from a plurality of nozzles to a predetermined row of a certain page; and the like. Note that, hereinafter, acceleration and deceleration of a conveyance speed of the print sheet will be simply referred to as “acceleration” and “deceleration,” respectively.

Regarding such a maintenance as described above, Japanese Laid-Open Patent Publication No. 2012-45854 describes that test patterns are printed at the time of acceleration before the printing is started and at the time of deceleration after the printing is ended, and that the maintenance is executed on the basis of a result obtained by capturing the printed test patterns by a scanner. Further, Japanese Laid-Open Patent Publication No. 2017-24287 describes that star flushing with a relatively large ink ejection amount is performed at the time of acceleration before the printing is started, and that star flushing with a relatively small ink ejection amount is performed during the printing.

Heretofore, it has been determined whether or not it is necessary to execute the cleaning on the basis of a result obtained by capturing, by a scanner, an inspection pattern printed before execution of a job (execution of printing). Work for this is performed by an operator, but a workload therefor is large for the operator. Further, it is difficult for the operator to identify an inkjet head where a lack (a lacking point) such as a nozzle lack is likely to occur, and therefore, it is conceivable that the operator executes the cleaning more than necessary. The cleaning can be executed only during the stop of the conveyance of the print sheet as mentioned above, and therefore, printing efficiency decreases in a case in which the cleaning is executed more than necessary.

### SUMMARY OF THE INVENTION

In this connection, it is an object of the present invention to provide a printing apparatus capable of reducing the operator's workload related to the maintenance and efficiently executing the maintenance.

One aspect of the present invention is directed to a printing apparatus including:

a conveying mechanism configured to convey a print medium;

a printing unit composed of a plurality of print heads configured to perform printing on the print medium by ejecting ink;

a cleaning mechanism configured to clean the printing unit;

an inspection device configured to inspect a print image obtained by printing;

a conveyance control unit configured to control a conveyance speed at which the conveying mechanism conveys the print medium;

a printing control unit configured to control operations of the printing unit and the cleaning mechanism; and

a maintenance content determination unit configured to determine a maintenance content for the printing unit, wherein

the conveyance control unit accelerates the print medium until the conveyance speed changes from 0 to a predetermined reference speed before printing based on each job is started, conveys the print medium so that the conveyance speed of the print medium is kept at a constant speed including the reference speed at least in a period during which the printing based on each job is being executed, and decelerates the print medium until the conveyance speed changes from the constant speed to 0 after the printing based on each job is ended,

the printing control unit controls an operation of the printing unit so that an inspection pattern is printed on the print medium in a period during which the conveyance speed is being kept at the constant speed,

the maintenance content determination unit determines the maintenance content for the printing unit based on an inspection result obtained by inspecting the print image for the inspection pattern by the inspection device, and

the printing control unit controls the operations of the printing unit and the cleaning mechanism in accordance with the maintenance content determined by the maintenance content determination unit.

With such a configuration, a maintenance content for a printing unit is determined by a maintenance content determination unit. The maintenance content is determined without requiring a determination of the operator, and accordingly, the operator's workload related to the maintenance is reduced. Further, conditions for a variety of determinations are set in advance so that the cleaning is not executed more than necessary regarding processing for determining the maintenance content, whereby it becomes possible to enhance efficiency of the maintenance. As above, achieved is the printing apparatus capable of reducing the operator's workload related to the maintenance and efficiently executing the maintenance. Further, the inspection pattern is printed in a state in which the print medium is conveyed at a constant speed. That is, the inspection pattern is printed in a state close to a state in which a main image (an image to be originally printed) is printed. Hence, the lack is detected accurately.

Another aspect of the present invention is directed to a maintenance method of a printing apparatus including: a printing unit composed of a plurality of print heads configured to perform printing on a print medium by ejecting ink; and a cleaning mechanism configured to clean the printing unit, the maintenance method including:

an inspection pattern printing step of causing the printing unit to print an inspection pattern to the print medium in a state in which the print medium is conveyed at a constant speed;

an inspection step of inspecting a print image obtained by printing the inspection pattern;

a maintenance content determination step of determining a maintenance content for the printing unit based on an inspection result obtained by inspecting the print image in the inspection step; and

a maintenance step of controlling operations of the printing unit and the cleaning mechanism depending on the maintenance content determined in the maintenance content determination step.

These and other objects, features, modes, and advantageous effects of the present invention will become more apparent from the following detailed description of the present invention with reference to the accompanying drawings.

### BRIEF DESCRIPTION OF THE DRAWINGS

FIG. 1 is an overall configuration diagram of a printing system according to a first embodiment of the present invention.

FIG. 2 is a schematic view illustrating one configuration example of an inkjet printing apparatus in the first embodiment.

FIG. 3 is a plan view illustrating one configuration example of a printing unit in the first embodiment.

FIG. 4 is a block diagram illustrating a hardware configuration of a printing control device in the first embodiment.

FIG. 5 is a block diagram illustrating a schematic functional configuration of a control unit in the first embodiment.

FIG. 6 is a view for explaining a relationship between conveyance of a print sheet and a maintenance in the first embodiment.

FIG. 7 is a block diagram illustrating a functional configuration related to a control of the maintenance in the first embodiment.

FIG. 8 is a flowchart illustrating a schematic procedure of processing related to the control of the maintenance in the first embodiment.

FIG. 9 is a flowchart illustrating a detailed procedure of maintenance content determination processing in the first embodiment.

FIG. 10 is a block diagram illustrating a functional configuration related to the control of the maintenance in a second embodiment of the present invention.

FIG. 11 is a flowchart illustrating a procedure of processing related to the control of the maintenance in the second embodiment.

FIG. 12 is a view for explaining processing at a time of printing interruption in the second embodiment.

FIG. 13 is a view for explaining the processing at the time of the printing interruption in the second embodiment.

FIG. 14 is a block diagram illustrating a functional configuration related to the control of the maintenance in a modified example of the second embodiment.

FIG. 15 is a flowchart illustrating a procedure of processing related to the control of the maintenance in the modified example of the second embodiment.

### DETAILED DESCRIPTION OF PREFERRED EMBODIMENTS

Embodiments of the present invention will be described below with reference to the accompanying drawings.

### 1. First Embodiment

### 1.1 Overall Configuration of Printing System

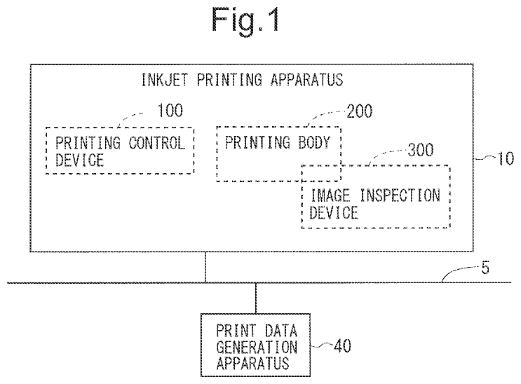

FIG. 1 is an overall configuration diagram of a printing system according to a first embodiment of the present invention. This printing system is composed of an inkjet printing apparatus 10 and a print data generation apparatus 40. The inkjet printing apparatus 10 and the print data generation apparatus 40 are connected to each other by a communication line 5. The print data generation apparatus 40 implements RIP processing and the like for submitted data such as a PDF file to generate print data. The print data generated by the print data generation apparatus 40 is transmitted to the inkjet printing apparatus 10 through the communication line 5. The inkjet printing apparatus 10 outputs a print image to a print sheet as a print medium on the basis of the print data, which is transmitted from the print data generation apparatus 40, without using a printing plate. The inkjet printing apparatus 10 is composed of: a printer body 200; a printing control device 100 that controls an operation of the printer body 200; and an image inspection device 300 that inspects a print state. That is, this inkjet printing apparatus 10 is a printing apparatus added with an inspection function. A part of constituents of the image inspection device 300 is built in the printer body 200.

Note that, in the configuration illustrated in FIG. 1, the image inspection device 300 is one constituent of the inkjet printing apparatus 10 (that is, the image inspection device 300 is included in the inkjet printing apparatus 10). However, the present invention is not limited thereto. The image inspection device 300 may be one device independent of the inkjet printing apparatus 10.

### 1.2 Configuration of Inkjet Printing Apparatus

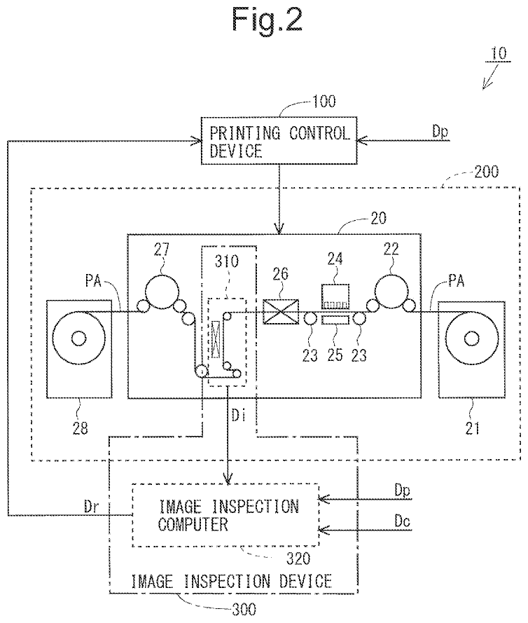

FIG. 2 is a schematic view illustrating one configuration example of the inkjet printing apparatus 10. As mentioned above, this inkjet printing apparatus 10 is composed of the printing control device 100, the printer body 200, and the image inspection device 300.

The printer body 200 includes: a sheet sending unit 21 that supplies a print sheet (for example, roll paper) PA; a printing mechanism 20 that performs printing on the print sheet PA; and a sheet winding unit 28 that winds off the printed print sheet PA. The printing mechanism 20 includes: a first drive roller 22 for conveying the print sheet PA to an inside thereof; a plurality of support rollers 23 for conveying the print sheet PA in the inside of the printing mechanism 20; a printing unit 24 that performs printing on the print sheet PA by ejecting ink; a cleaning mechanism 25 that performs cleaning (for example, suction of ink from a nozzle which will be described later and wiping of a nozzle surface) for the printing unit 24; a drying unit 26 that dries the printed print sheet PA; an imaging unit 310 that images a print image (the printed print sheet PA); and a second drive roller 27 for outputting the print sheet PA from the inside of the printing mechanism 20. The imaging unit 310 is a constituent of the image inspection device 300, and may be composed of an image sensor such as a CCD and a CMOS.

The printing control device 100 controls an operation of the printer body 200 having such a configuration as described above. When the printing control device 100 is given an instruction command for printout, the printing control device 100 controls the operation of the printer body 200 so that the print sheet PA is conveyed from the sheet sending unit 21 to the sheet winding unit 28. Then, first, printing on the print sheet PA is performed by the printing unit 24, next, the print sheet PA is dried by the drying unit 26, and finally, the print image is imaged by the imaging unit 310. Further, according to needs, the printing unit 24 is cleaned by the cleaning mechanism 25.

The image inspection device 300 is composed of the imaging unit 310 and an image inspection computer 320. Imaged image data Di obtained by the imaging of the print image by the imaging unit 310 is sent to the image inspection computer 320. In the image inspection computer 320, an inspection for detecting a lack (a lacking point) is performed by image analysis for the imaged image data Di. Note that, without being limited to such a technique, the inspection or the like for detecting the lack (the lacking point) may be performed by comparing and collating the imaged image data Di with print data Dp transmitted from the print data generation apparatus 40 or by comparing and collating the imaged image data Di with inspection image data Dc. An inspection result Dr obtained by the image inspection computer 320 is sent to the printing control device 100.

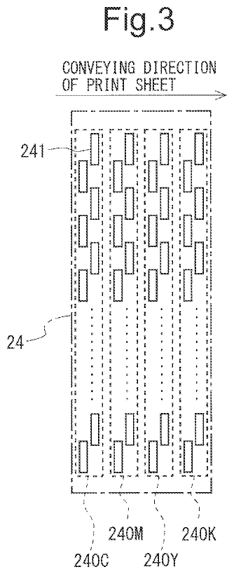

FIG. 3 is a plan view illustrating one configuration example of the printing unit 24. As illustrated in FIG. 3, the printing unit 24 is composed of inkjet head arrays 240C, 240M, 240Y and 240K for a C color (a cyan color), an M color (a magenta color), a Y color (a yellow color) and a K color (a black color), which are arranged in line in a conveying direction of the print sheet PA. Each of the inkjet head arrays is composed of a plurality of inkjet heads (print heads) 241 arranged in a zigzag pattern. A large number of nozzles which eject ink are included in each of the inkjet heads 241. The respective nozzles of the inkjet heads 241 included in the inkjet head array 240C for the C color eject ink of the C color, the respective nozzles of the inkjet heads 241 included in the inkjet head array 240M for the M color eject ink of the M color, the respective nozzles of the inkjet heads 241 included in the inkjet head array 240Y for the Y color eject ink of the Y color, and the respective nozzles of the inkjet heads 241 included in the inkjet head array 240K for the K color eject ink of the K color.

Note that, though the configuration of the inkjet printing apparatus 10 that performs color printing is illustrated herein, the present invention can also be applied to the case where an inkjet printing apparatus that performs monochrome printing is adopted. Moreover, though the configuration of the inkjet printing apparatus 10 using aqueous ink is illustrated herein, the present invention can also be applied, for example, to the case where an inkjet printing apparatus using UV ink (ultraviolet curing ink), such as an inkjet printing apparatus for label printing, is adopted. As above, the type of the printing apparatus is not particularly limited as long as the printing unit that needs cleaning is provided.

### 1.3 Hardware Configuration of Printing Control Device

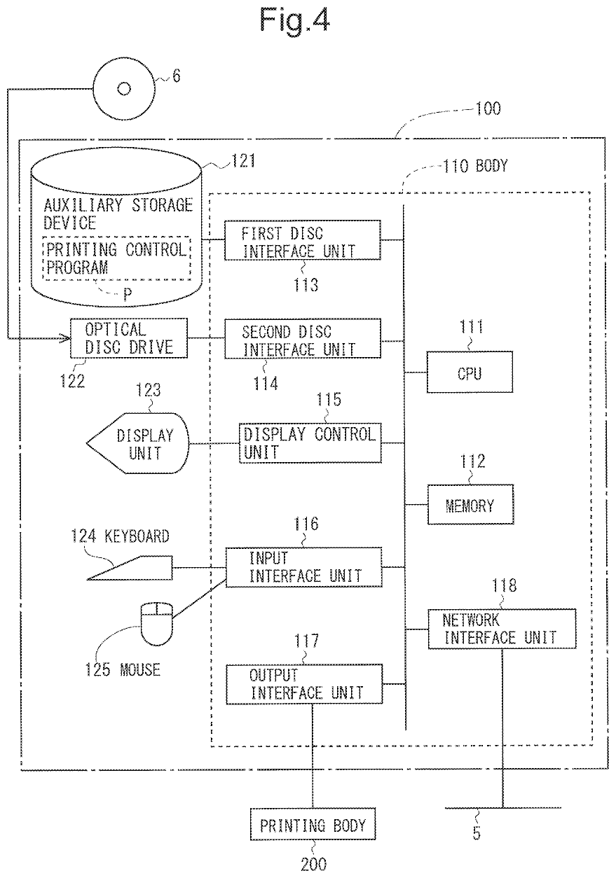

FIG. 4 is a block diagram illustrating a hardware configuration of the printing control device 100. As illustrated in FIG. 4, the printing control device 100 includes a body 110, an auxiliary storage device 121, an optical disc drive 122, a display unit 123, a keyboard 124, a mouse 125, and the like. The body 110 includes a CPU 111, a memory 112, a first disc interface unit 113, a second disc interface unit 114, a display control unit 115, an input interface unit 116, an output interface unit 117, and a network interface unit 118. The CPU 111, the memory 112, the first disc interface unit 113, the second disc interface unit 114, the display control unit 115, the input interface unit 116, the output interface unit 117, and the network interface unit 118 are connected to one another through a system bus. The auxiliary storage device 121 is connected to the first disc interface unit 113. The optical disc drive 122 is connected to the second disc interface unit 114. The display unit (a display device) 123 is connected to the display control unit 115. The keyboard 124 and the mouse 125 are connected to the input interface unit 116. The printer body 200 is connected to the output interface unit 117 through a communication cable. The communication line 5 is connected to the network interface unit 118. The auxiliary storage device 121 is a magnetic disk device or the like. Into the optical disc drive 122, an optical disc 6 is inserted, which serves as a computer-readable recording medium such as a CD-ROM and a DVD-ROM. The display unit 123 is a liquid crystal display or the like. The display unit 123 is used for displaying information desired by an operator. The keyboard 124 and the mouse 125 are used for the operator to input an instruction to this printing control device 100.

In the auxiliary storage device 121, there is stored a printing control program (a program for controlling execution of printing processing by the printer body 200) P. The CPU 111 reads out the printing control program P, which is stored in the auxiliary storage device 121, into the memory 112, and executes the same, thereby achieving a variety of functions of the printing control device 100. The memory 112 includes a RAM and a ROM. The memory 112 functions as a work area for causing the CPU 111 to execute the printing control program P stored in the auxiliary storage device 121. Note that the printing control program P is provided while being stored in the above-described computer-readable recording medium (a non-transitory recording medium). That is, for example, a user purchases the optical disc 6 as the recording medium of the printing control program P, inserts the optical disc 6 into the optical disc drive 122, reads out the printing control program P from the optical disc 6, and installs the printing control program P to the auxiliary storage device 121. Alternatively, in place of this, the user may receive the printing control program P, which is transmitted through the communication line 5, by the network interface unit 118, and may install the printing control program P to the auxiliary storage device 121.

### 1.4 Control Unit

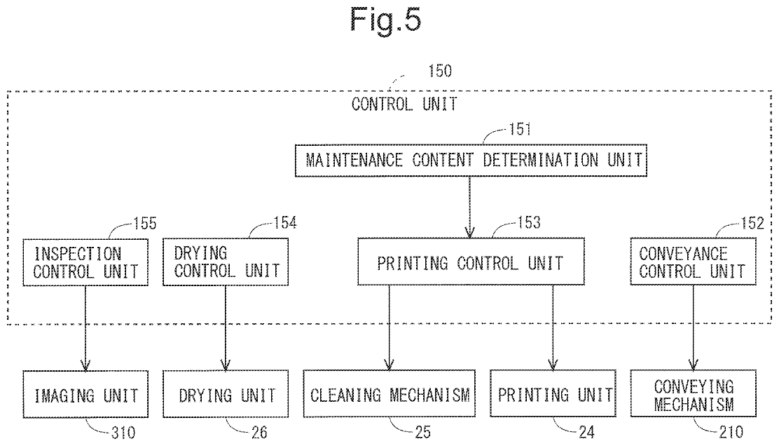

FIG. 5 is a block diagram illustrating a schematic functional configuration of the control unit 150 achieved by the execution of the printing control program P in the printing control device 100. Schematically, the control unit 150 includes a maintenance content determination unit 151, a conveyance control unit 152, a printing control unit 153, a drying control unit 154, and an inspection control unit 155.

The maintenance content determination unit 151 determines a maintenance content for the printing unit 24 (more specifically, the inkjet heads 241) on the basis of a result of an inspection by the image inspection device 300 (that is, the inspection result Dr obtained by the image inspection computer 320).

The conveyance control unit 152 controls a speed (a conveyance speed) at which a conveying mechanism 210 conveys the print sheet PA. Note that, in the present embodiment, the conveying mechanism 210 is achieved by the sheet sending unit 21, the first drive roller 22, the plurality of support rollers 23, the second drive roller 27 and the sheet winding unit 28 (see FIG. 2).

The printing control unit 153 controls the ejection of the ink from each of the nozzles included in each of the inkjet heads 241 which constitute the printing unit 24. For example, ejection timing of the ink and an ejection amount of the ink are controlled. The printing control unit 153 further controls an operation of the cleaning mechanism 25. Note that, when the maintenance of the printing unit 24 is performed, the printing control unit 153 controls the operations of the printing unit 24 and the cleaning mechanism 25 depending on the maintenance content determined by the maintenance content determination unit 151.

The drying control unit 154 controls a temperature (a drying temperature) when the drying unit 26 dries the print sheet PA. The inspection control unit 155 controls imaging timing of the print image by the imaging unit 310.

Incidentally, when processing of each job is executed, first, the conveyance control unit 152 controls the operation of the conveying mechanism 210 so that the conveyance of the print sheet PA, which is stopped, is started. The conveyance speed gradually increases. When the conveyance speed reaches a preset reference speed (a speed suitable for printing), the conveyance speed is constantly kept at the reference speed. Then, usually, printing on the print sheet PA is performed under a situation where the conveyance speed is kept at the reference speed (that is, under a situation where the print sheet PA is conveyed at a constant speed). After the printing is ended, the conveyance control unit 152 controls the operation of the conveying mechanism 210 so that the conveyance speed gradually decreases. Thus, the conveyance of the print sheet PA is stopped. Note that, in a period during which printing on the print sheet PA conveyed at the reference speed is performed, a slow request signal to request a decrease of the printing speed is issued as a notice from a post-processing apparatus side (not shown), which is connected in line to the inkjet printing apparatus 10, to the inkjet printing apparatus 10 depending on a state of progress of post processing. When the inkjet printing apparatus 10 receives such a notice, the conveyance control unit 152 controls the operation of the conveying mechanism 210 so that the conveyance speed of the print sheet PA is decelerated from the reference speed to a predetermined low speed and conveyance of the print sheet PA is continued while constantly keeping this low speed. The printing is continued also while the print sheet PA is conveyed at such a low speed. Then, when the slow request signal is released, the conveyance control unit 152 controls the operation of the conveying mechanism 210 so that the print sheet PA is conveyed while constantly keeping the conveyance speed at the reference speed after the conveyance speed of the print sheet PA is accelerated from the low speed to the reference speed, and printing on the print sheet PA conveyed while keeping the reference speed is performed continuously. When the printing is ended, the conveyance control unit 152 controls the operation of the conveying mechanism 210 so that the conveyance speed gradually decreases from the reference speed. Thus, the conveyance of the print sheet PA is stopped. Meanwhile, when the slow request signal is not released, the conveyance control unit 152 controls the operation of the conveying mechanism 210 so that conveyance of the print sheet PA is continued while constantly keeping the conveyance speed at the low speed, and the printing on the print sheet PA conveyed at such a constant low speed is also continued. Then, when the printing is ended, the conveyance control unit 152 controls the operation of the conveying mechanism 210 so that the conveyance speed further gradually decreases from the constant low speed. Thus, the conveyance of the print sheet PA is stopped.

As above, the conveyance control unit 152 accelerates the print sheet PA until the conveyance speed changes from 0 to the reference speed before the printing based on each job is started, keeps the conveyance speed at a constant speed at least throughout a period during which the printing based on each job is being executed, and decelerates the print sheet PA until the conveyance speed changes from the constant speed to 0 after the printing based on each job is ended.

### 1.5 Control of Maintenance

In the inkjet printing apparatus 10 according to the present embodiment, a maintenance for the printing unit 24 (more specifically, the inkjet head 241) is performed on the basis of the result of the inspection by the image inspection device 300. Regarding this, in the present embodiment, after the printing based on each job is ended, processing for determining whether or not it is necessary to execute the maintenance or determining a type of the maintenance is performed (this processing will be hereinafter referred to as “maintenance content determination processing”). Then, the operations of the printing unit 24 and the cleaning mechanism 25 are controlled by the printing control unit 153 depending on a result of the maintenance content determination processing, whereby the maintenance for the printing unit 24 is performed as desired.

Incidentally, in the present embodiment, when the printing based on each job is executed, inspection patterns for inspecting a lack (a lacking point such as a nozzle lack) are added to the print data Dp of each job. Specifically, the inspection patterns are added to the head and end of the print data Dp of each job. The inspection pattern added to the head of the print data Dp and the inspection pattern added to the end of the print data Dp may be the same pattern, or may be different patterns from each other. Note that, hereinafter, the inspection pattern added to the head of the print data Dp will be referred to as a “first inspection pattern”, and the inspection pattern added to the end of the print data Dp will be referred to as a “second inspection pattern”. Moreover, for convenience, an image (an image to be originally printed) based on the print data Dp sent from the print data generation apparatus 40 will be referred to as a “main image”.

Each of the first inspection pattern, the main image and the second inspection pattern is printed when the print sheet PA is conveyed at a constant speed. Specifically, usually, after the conveyance speed of the print sheet PA changes from 0 to the reference speed, the first inspection pattern, the main image and the second inspection pattern are sequentially printed, and thereafter, the conveyance speed of the print sheet PA changes from the reference speed to 0. Further, in some cases, the inkjet printing apparatus 10 receives the above-mentioned slow request signal when printing on the print sheet PA conveyed at the reference speed is performed, the conveyance speed of the print sheet PA is decelerated from the reference speed to the predetermined low speed, and printing on the print sheet PA is performed completely to the end in a state in which such a low speed is constantly kept. Also in such a case, at least the printing of a part of the main image and the printing of the second inspection pattern are performed in a state in which the print sheet PA is conveyed at a constant speed thought this speed is a lower speed than the reference speed. Then, after the second inspection pattern is printed, the conveyance speed of the print sheet PA changes from such a low speed lower than the reference speed to 0.

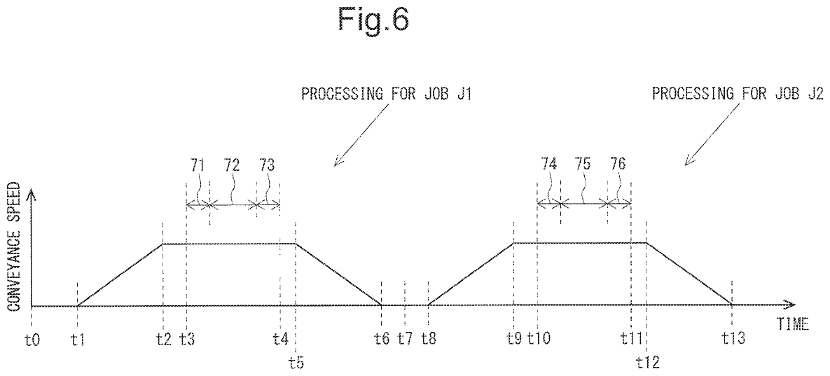

Referring to FIG. 6, a relationship between the conveyance of the print sheet PA and the maintenance will be described. Herein, it is assumed that processing for a job J1 is performed in a period from a time t1 to a time t6, and that processing for a job J2 is performed in a period from a time t8 to a time t13, and attention is paid to the maintenance content determination processing performed after printing based on the job J1 is ended.

After a print instruction for the job J1 is issued at a time t0, the conveyance speed gradually increases from the time t1, and the conveyance speed reaches the above-mentioned reference speed at the time t2. Thereafter, in a period from the time t3 to the time t4, the first inspection pattern, the main image and the second inspection pattern are printed. Specifically, the first inspection pattern is printed in a period indicated by an arrow denoted by reference numeral 71, the main image is printed in a period indicated by an arrow denoted by reference numeral 72, and the second inspection pattern is printed in a period indicated by an arrow denoted by reference numeral 73. As above, in such a period during which the conveyance speed is being kept at the reference speed, the first inspection pattern, the main image and the second inspection pattern are printed.

After the printing based on the job J1 is ended, the conveyance speed gradually decreases from the time t5, and the conveyance of the print sheet is stopped at the time t6. In a period from the time t4 to the time t6, the second inspection pattern printed in the period indicated by the arrow denoted by reference numeral 73 is inspected, and further, on the basis of a result of this inspection, the maintenance content determination processing is performed. When a determination to execute the cleaning is made in the maintenance content determination processing, the cleaning of the printing unit 24 by the cleaning mechanism 25 is executed immediately after the time t6.

After a print instruction for the job J2 is issued at a time t7, the conveyance speed gradually increases from a time t8, and the conveyance speed reaches the reference speed at a time t9. When a determination to execute flushing is made in the maintenance content determination processing performed after the printing based on the job J1 is ended, then in a period from the time t8 to the time t10, the flushing is executed on the basis of the control of the printing unit 24 by the printing control unit 153.

Thereafter, in a period from the time t10 to a time t11, the first inspection pattern, the main image and the second inspection pattern are printed. Specifically, the first inspection pattern is printed in a period indicated by an arrow denoted by reference numeral 74, the main image is printed in a period indicated by an arrow denoted by reference numeral 75, and the second inspection pattern is printed in a period indicated by an arrow denoted by reference numeral 76. After the printing based on the job J2 is ended, the conveyance speed gradually decreases from a time t12, and the conveyance of the print sheet is stopped at a time t13.

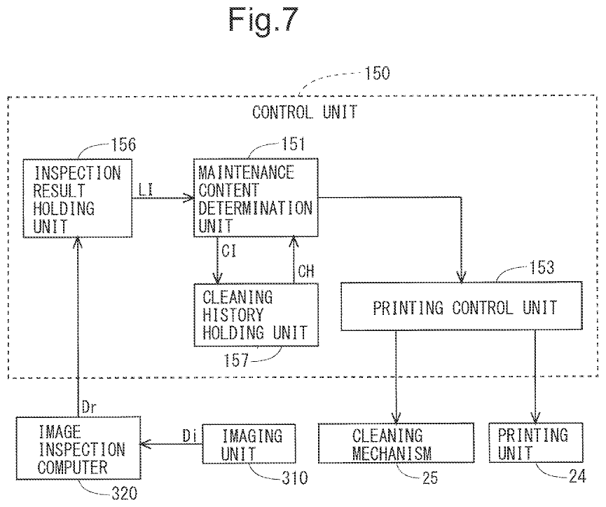

FIG. 7 is a block diagram illustrating a functional configuration related to the control of the maintenance. In addition to the above-mentioned maintenance content determination unit 151, the control unit 150 is provided with an inspection result holding unit 156 and a cleaning history holding unit 157 as constituents required to execute the maintenance content determination processing. Further, the printing control unit 153, the printing unit 24, the cleaning mechanism 25, the imaging unit 310 and the image inspection computer 320 are involved in the control of the maintenance.

The inspection result holding unit 156 holds the inspection result Dr sent from the image inspection computer 320. In the maintenance content determination processing, there is used lack information LI as an inspection result regarding the lack (the lacking point) such as the nozzle lack in the inspection result Dr sent from the image inspection computer 320. The cleaning history holding unit 157 holds cleaning information CI sent from the maintenance content determination unit 151. The cleaning information CI accumulated in the cleaning history holding unit 157 is referred to as a cleaning history CH by the maintenance content determination unit 151 at the time of the maintenance content determination processing. The maintenance content determination unit 151 performs the maintenance content determination processing, which will be described below in detail, on the basis of the lack information LI and the cleaning history CH. Then, the printing control unit 153 controls the operations of the printing unit 24 and the cleaning mechanism 25 so that the maintenance of the content determined by the maintenance content determination processing is executed.

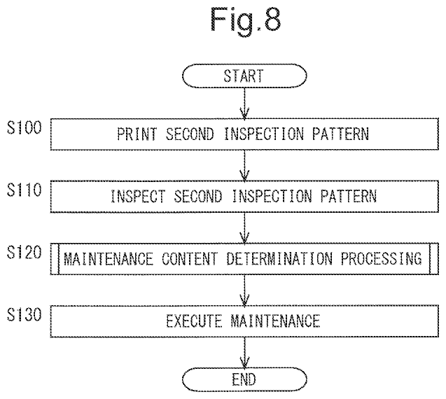

Referring to FIG. 8, a description will be given of a schematic procedure of the processing related to the control of the maintenance. First, after the printing based on a processing target job is ended, the second inspection pattern is printed on the print sheet PA by the printing unit 24 (Step S100). Note that, as mentioned above, the second inspection pattern is printed in the period during which the conveyance speed of the print sheet PA is being kept at the reference speed.

Next, the print image for the second inspection pattern is inspected by the image inspection device 300 (Step S110). Regarding this, first, the print image obtained by the printing in Step S100 (the printing of the second inspection pattern on the print sheet PA) is imaged by the imaging unit 310. Next, the imaged image data Di obtained by the imaging by the imaging unit 310 is sent to the image inspection computer 320. Then, in the image inspection computer 320, the image analysis for the imaged image data Di is performed. In such a manner as described above, the lack (the lacking point) is detected on the basis of the print image for the second inspection pattern.

After the print image for the second inspection pattern is inspected, the maintenance content determination processing is performed (Step S120). Thus, the content of the maintenance to be executed until printing based on a next job is started is determined. A detailed description will be given later of the maintenance content determination processing. Note that, typically, the processing of Step S110 is performed in the period during which the conveyance speed of the print sheet PA is being kept at the reference speed, and the processing of Step 3120 is performed in the period during which the conveyance speed of the print sheet PA is being decelerated.

After the maintenance content determination processing is ended, the maintenance of the content determined by the maintenance content determination processing is executed (Step S130). However, when a determination that the maintenance is not necessary is made by the maintenance content determination processing, the maintenance is not executed. When the determination to execute the cleaning is made by the maintenance content determination processing, then in a period during which the conveyance of the print sheet PA is being stopped, the cleaning of the printing unit 24 is executed on the basis of the control for the operations of the printing unit 24 and the cleaning mechanism 25 by the printing control unit 153. When the determination to execute the flushing is made by the maintenance content determination processing, then in the period from the resume of the conveyance of the print sheet PA to the start of the printing, which is based on the next job, the flushing (for example, line flushing) is executed on the basis of the control of the printing unit 24 by the printing control unit 153.

Note that, in the present embodiment, an inspection pattern printing step is achieved by Step S100, an inspection step is achieved by Step S110, a maintenance content determination step is achieved by Step S120, and a maintenance step is achieved by Step 3130.

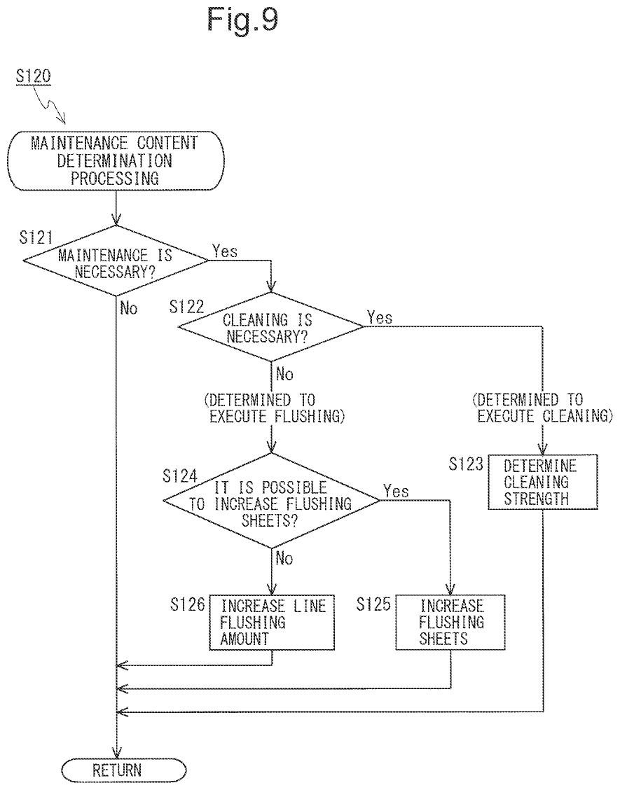

Next, referring to FIG. 9, a procedure of the maintenance content determination processing (the processing of Step S120 in FIG. 8) will be described. This maintenance content determination processing is performed by the maintenance content determination unit 151. As mentioned above, in the present embodiment, the maintenance content determination processing is performed after the printing based on each job is ended. Note that the procedure to be described below is merely an example, and the present invention is not limited to this.

After the maintenance content determination processing is started, first, on the basis of an inspection result for the second inspection pattern printed immediately before, it is determined whether or not it is necessary to execute the maintenance for the printing unit 24 (Step S121). For example, the number of lacks, which is indicated by the inspection result for the second inspection pattern printed immediately before, and a predetermined threshold value are compared with each other, and when the number of lacks is equal to or more than the threshold value, it is determined that it is necessary to execute the maintenance, and when the number of lacks is less than the threshold value, it is determined that it is not necessary to execute the maintenance. Further, for example, a size (an area) of a maximum lack, which is indicated by the inspection result for the second inspection pattern printed immediately before, and a predetermined threshold value are compared with each other, and when the size of the maximum lack is equal to or more than the threshold value, it is determined that it is necessary to execute the maintenance, and when the size of maximum lack is less than the threshold value, it is determined that it is not necessary to execute the maintenance.

When it is determined in Step S121 that it is not necessary to execute the maintenance, this maintenance content determination processing is ended. In this case, the printing based on the next job is started without execution of the maintenance for the printing unit 24. When it is determined in Step S121 that it is necessary to execute the maintenance, the processing proceeds to Step S122.

In Step S122, on the basis of the inspection result for the second inspection pattern printed immediately before, it is determined whether or not it is necessary to execute the cleaning of the printing unit 24. For example, this determination is also performed on the basis of the result of the comparison between a predetermined threshold value and the number of lacks or the size of the maximum lack, which are indicated by the inspection result for the second inspection pattern printed immediately before. Regarding this, if a configuration is adopted in which the determinations in Step S121 and Step S122 are performed on the basis of the result of the comparison between the threshold values and the numbers of lacks, the threshold value for use in Step S122 is set to a value larger than the threshold value for use in Step S121.

When it is determined in Step S122 that it is necessary to execute the cleaning, it is decided to execute the cleaning, and the processing proceeds to Step S123. Meanwhile, when it is determined in Step S122 that it is not necessary to execute the cleaning, it is decided to execute the flushing, and the processing proceeds to Step S124.

In Step S123, a strength (a cleaning strength) at the time of cleaning the printing unit 24 is determined. This determination is made on the basis of the inspection result for the second inspection pattern printed immediately before and inspection results for the second inspection pattern printed in the past. For example, if the lack is detected in the same inkjet head consecutively a predetermined number of times or more, a cleaning strength at the current time is set to a strength higher than a cleaning strength when the cleaning was executed the previous time, and otherwise, the cleaning strength at the current time is set to the same strength as the cleaning strength when the cleaning was executed the previous time. Note that the cleaning strength when the cleaning was executed the previous time can be grasped by referring to the above-mentioned cleaning history CH. Regarding lowering of the increased cleaning strength, for example, there is conceived a rule of lowering a cleaning strength at the next cleaning time to a normal strength when it is found that the lack is solved after cleaning at the maximum strength is executed.

When the processing in Step S123 is ended, this maintenance content determination processing is ended. In this case, in a conveyance stop period of the print sheet PA when a printing target shifts from the job immediately before to the next job, the cleaning is executed at the cleaning strength set in Step S123.

In Step S124, it is determined whether or not it is possible to increase the number of flushing sheets at the time of executing the flushing. Regarding this, if a setting to use the flushing sheets is made, then it is determined that the number of flushing sheets can be increased, and if the setting to use the flushing sheets is not made, then it is determined that the number of flushing sheets cannot be increased. Note that the flushing sheets refer to sheets on which a special pattern for solving the lack is printed. Hereinafter, this pattern will be referred to as a “lack-solving pattern”. Hence, the above-described “to use the flushing sheets” means “to print the lack-solving pattern” When it is determined in Step S124 that the number of flushing sheets can be increased, the processing proceeds to Step S125. When it is determined in Step S124 that the number of flushing sheets cannot be increased, the processing proceeds to Step S126.

In Step S125, the number of flushing sheets during the current flushing is set to a larger number than the number of flushing sheets during the previous flushing. At that time, a difference between the number of flushing sheets during the current flushing and the number of flushing sheets during the previous flushing is determined, for example, on the basis of the inspection result for the second inspection pattern printed immediately before. Note that, the configuration may be such that, on the basis of the inspection result of the second inspection pattern printed immediately before and the inspection results of the second inspection pattern printed in the past, the number of flushing sheets during the current flushing is set to a much larger number when the lack is detected in the same inkjet head consecutively a predetermined number of times. When the processing in Step 3125 is ended, this maintenance content determination processing is ended. In this case, in an acceleration period of the conveyance speed of the print sheet PA, which serves for starting the printing based on the next job, printing of the lack-solving pattern (that is, flushing of printing the lack-solving pattern) is performed depending on the number set in Step S125.

In Step S126, a flushing amount during the current flushing is set to a larger amount than a flushing amount during the previous flushing. At that time, a difference between the flushing amount during the current flushing and the flushing amount during the previous flushing is determined, for example, on the basis of the inspection result of the second inspection pattern printed immediately before. Note that, the configuration may be such that, on the basis of the inspection result for the second inspection pattern printed immediately before and the inspection results for the second inspection pattern printed in the past, the flushing amount during the current flushing is set to a much larger amount when the lack is detected in the same inkjet head consecutively a predetermined number of times. When the processing in Step S126 is ended, this maintenance content determination processing is ended. In this case, in the acceleration period of the conveyance speed of the print sheet PA, which serves for starting the printing based on the next job, line flushing with the flushing amount set in Step S126 is executed. Note that, as a matter of course, the line flushing may be performed after the conveyance speed of the print sheet PA, which serves for starting the printing based on the next job, reaches the reference speed. However, the line flushing is performed by using the acceleration period before the conveyance speed reaches the reference speed suitable for the main printing, whereby the period during which the conveyance speed of the print sheet PA is kept at the constant speed suitable for the printing can be efficiently utilized for the main printing.

Incidentally, the maintenance (the cleaning or the flushing) may be performed commonly to all the inkjet heads 241, or may be performed for only the inkjet heads 241 from which the lacks are detected.

Note that, when a setting to use the flushing sheets is made, even if it is determined in this maintenance content determination processing that it is not necessary to execute the maintenance, minimal flushing corresponding to the number of flushing sheets set by the user is executed before the printing based on the next job is executed. Further, when the setting to use the flushing sheets is not made, even if it is determined in this maintenance content determination processing that it is not necessary to execute the maintenance, line flushing with a minimal flushing amount is executed before the printing based on the next job is executed.

### 1.6 Effect

According to the present embodiment, the maintenance content determination unit 151 determines whether or not it is necessary to execute the maintenance for the printing unit 24 and determines the type of the maintenance when it is necessary to execute the maintenance. Thus, the content of the maintenance is determined without requiring the determination of the operator, and accordingly, the operator's workload related to the maintenance is reduced. Further, the conditions for the variety of determinations in the maintenance content determination processing are set in advance so that the cleaning is not executed more than necessary, whereby it becomes possible to enhance the efficiency of the maintenance. As above, according to the present embodiment, achieved is the inkjet printing apparatus 10 capable of reducing the operator's workload related to the maintenance and efficiently executing the maintenance.

Further, according to the present embodiment, the second inspection pattern for use in detecting the lack is printed in a state in which the print sheet PA is conveyed at a constant speed. That is, the second inspection pattern is printed in a state close to the state in which the main image is printed. Hence, the lack is detected accurately.

### 2. Second Embodiment

### 2.1 Overview and Configuration

In the above-described first embodiment, the description is given on the assumption that the printing based on each of the jobs is ended without any problem. However, there is desired such a configuration in which a similar effect to that in the above-described first embodiment is obtained even if the printing is interrupted due to some reason. Accordingly, a printing system with such a configuration will be described below as a second embodiment of the present invention.

In the present embodiment, when the printing is interrupted due to the printer body 200, the maintenance content determination processing and the maintenance having the content determined thereby are executed similar to the case where the printing based on each job is ended in the above-described first embodiment. Herein, an event in which a remaining amount of roll paper in the sheet sending unit 21 (see FIG. 2) is reduced to a predetermined value or less will be taken as an example of such an event in which the printing is interrupted. Note that a print medium supply unit is achieved by the sheet sending unit 21.

An overall configuration of the printing system, a configuration of the inkjet printing apparatus 10, a configuration of the printing unit 24, a hardware configuration of the printing control device 100 and a schematic functional configuration of the control unit 150 are similar to those of the above-described first embodiment, and accordingly, a description thereof will be omitted (see FIGS. 1 to 5).

### 2.2 Control of Maintenance

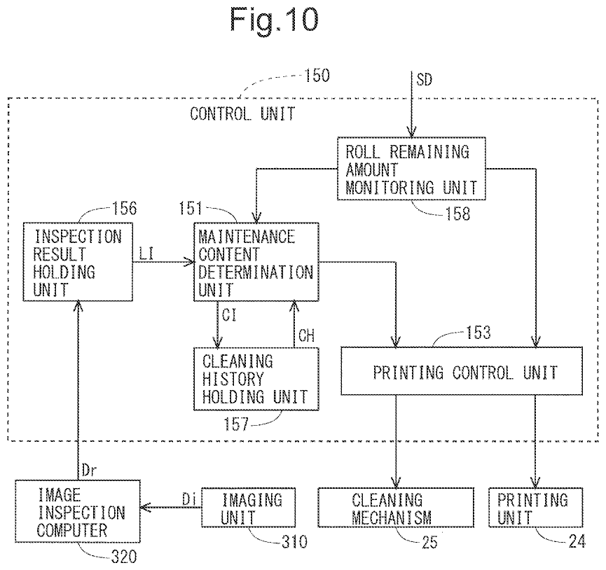

FIG. 10 is a block diagram illustrating a functional configuration related to the control of the maintenance. In the present embodiment, the control unit 150 is provided with a roll remaining amount monitoring unit 158 in addition to the constituents (see FIG. 7) in the above-described first embodiment. The roll remaining amount monitoring unit 158 monitors whether or not the remaining amount of the roll paper in the sheet sending unit 21 is reduced to the predetermined value or less, for example, on the basis of data SD obtained from a sensor provided inside the printer body 200. Upon detecting that the remaining amount of the roll paper is reduced to the predetermined value or less, the roll remaining amount monitoring unit 158 gives the printing control unit 153 an instruction to stop the printing, and instructs the maintenance content determination unit 151 to execute the maintenance content determination processing. In the present embodiment, a monitoring unit for detecting an event by which the printing should be interrupted is achieved by this roll remaining amount monitoring unit 158.

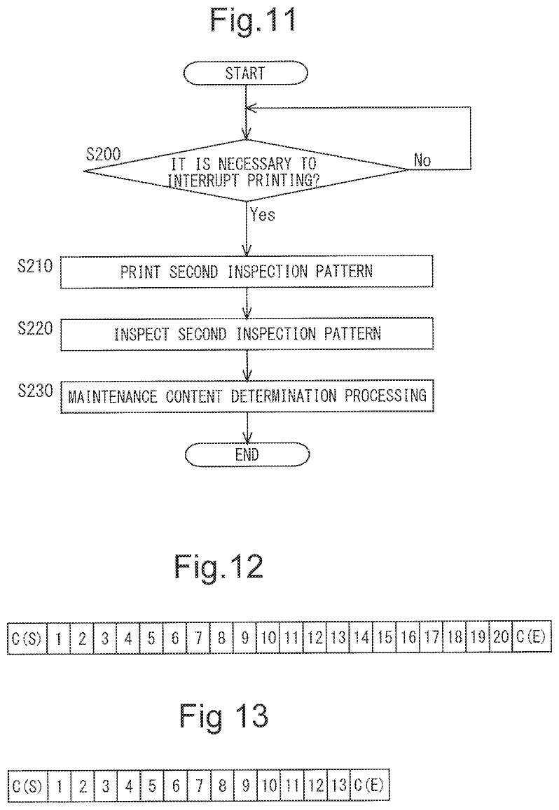

Referring to FIG. 11, a description will be given of a procedure of the processing related to the control of the maintenance in the present embodiment. Note that the procedure to be described herein is merely an example, and the present invention is not limited to this.

During the period while the printing is being executed, it is repeatedly determined whether or not there occurs the event by which the printing should be interrupted (Step S200). In the present embodiment, specifically, the roll remaining amount monitoring unit 158 determines whether or not the remaining amount of the roll paper is reduced to the predetermined value or less. When the remaining amount of the roll paper is not reduced to the predetermined value or less, it is not necessary to interrupt the printing, and the processing returns to Step S200. When the remaining amount of the roll paper is reduced to the predetermined value or less, it is necessary to interrupt the printing, and the processing proceeds to Step S210.

In Step S210, printing of the main image is stopped, and the above-mentioned second inspection pattern is printed. This will be described with reference to FIGS. 12 and 13. In the present embodiment, when there occurs the event by which the printing should be interrupted, the printing control unit 153 controls the operation of the printing unit 24 to stop the printing based on the processing target job and to print the second inspection pattern after a sheet that is being printed. For example, it is assumed that such a printing result as schematically illustrated in FIG. 12 is obtained when the printing is normally ended. Note that, in FIG. 12, reference symbol C(S) denotes the first inspection pattern, reference numerals 1 to 20 denotes first to 20th sheets of the main image, and reference symbol C(E) denotes the second inspection pattern. For example, when the event by which the printing should be interrupted occurs while the 13th sheet of the main image is being printed (specifically, when it is detected that the remaining amount of the roll paper is reduced to the predetermined value or less while the 13th sheet of the main image is being printed), the 14th to 20th sheets of the main image are not printed, and the second inspection pattern is printed after the 13th sheet of the main image is printed as schematically illustrated in FIG. 13. Then, the conveyance speed of the print sheet PA gradually decreases by the control of the conveying mechanism 210 by the conveyance control unit 152.

After the printing of the second inspection pattern is ended, the print image for the second inspection pattern is inspected by the image inspection device 300 (Step S220). In this Step S220, in a similar way to Step S110 (see FIG. 8) in the above-described first embodiment, the lack (the lacking point) is detected on the basis of the print image for the second inspection pattern.

Thereafter, the maintenance content determination processing is performed (Step S230). A procedure of the maintenance content determination processing is similar to that of the above-described first embodiment (See FIG. 9). That is, on the basis of an inspection result for the second inspection pattern printed immediately before, it is determined whether or not the maintenance for the printing unit 24 is required. Then, when it is determined that it is necessary to execute the maintenance for the printing unit 24, it is determined whether or not it is necessary to execute the cleaning of the printing unit 24 on the basis of the inspection result for the second inspection pattern printed immediately before.

Note that, in the above-described example, the printing is interrupted while the 13th sheet of the main image is being printed. In this case, regarding the relevant job, printing of the main image on new roll paper may be redone from the first sheet, or may be performed from the 14th sheet.

### 2.3 Effect

According to the present embodiment, when the printing is interrupted due to the printer body 200, then in a similar way to the above-described first embodiment, it is determined whether or not it is necessary to execute the maintenance for the printing unit 24, and the type of the maintenance when it is necessary to execute the maintenance is determined. Hence, in a similar way to the above-described first embodiment, also in the present embodiment, achieved is the inkjet printing apparatus 10 capable of reducing the operator's workload related to the maintenance and efficiently executing the maintenance.

Incidentally, in recent years, an inkjet printing apparatus 10 has been developed, which has a function to automatically switch the roll paper with a reduced remaining amount in the sheet sending unit 21 to new roll paper without human intervention. This function is called, for example, “auto splicing.” When the configuration of the present embodiment is applied to the inkjet printing apparatus 10 that has such a function, the necessary maintenance is surely performed when the roll paper is switched. Specifically, while the printing on the new roll paper is being prepared, the cleaning and the flushing are automatically performed for the printing unit 24. This makes it possible to keep good printing quality.

### 2.4 Modified Example

In the above-described second embodiment, the maintenance content determination processing is performed when the printing is interrupted due to the printer body 200. However, the printing may be interrupted due to the matter other than the printer body 200. Accordingly, as a modified example of the above-described second embodiment, a case will be described in which the printing is interrupted on the basis of an inspection result of the first inspection pattern added to the head of the print data Dp.

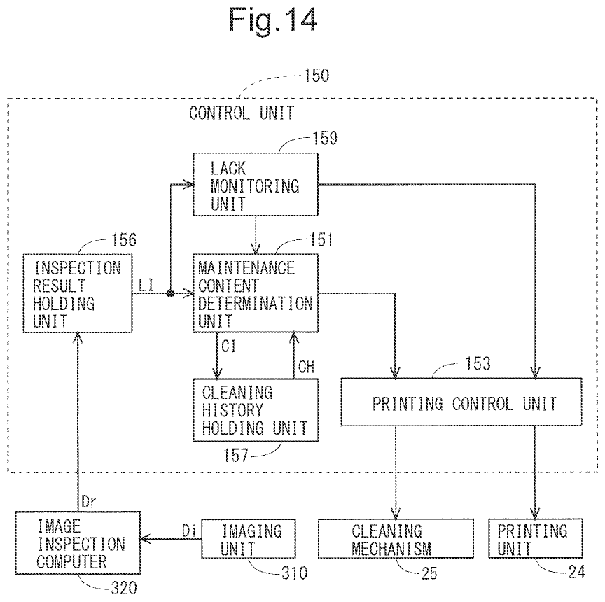

FIG. 14 is a block diagram illustrating a functional configuration related to a control of the maintenance in the present modified example. In the present modified example, the control unit 150 is provided with a lack monitoring unit 159 in place of the roll remaining amount monitoring unit 158 (see FIG. 10) in the above-described second embodiment. The lack monitoring unit 159 monitors whether or not the inspection result for the first inspection pattern meets a lack condition already set by the user while referring to the lack information LI held in the inspection result holding unit 156. Upon detecting that the inspection result for the first inspection pattern meets the lack condition, the lack monitoring unit 159 gives the printing control unit 153 the instruction to stop the printing, and instructs the maintenance content determination unit 151 to execute the maintenance content determination processing. In the present modified example, the monitoring unit for detecting the event by which the printing should be interrupted is achieved by this lack monitoring unit 159. Note that a content of the maintenance content determination processing is largely different from those of the above-described first embodiment and the above-described second embodiment. This will be described later.

Herein, the lack condition will be described. It is possible for the user to register the lack condition in the printing control device 100 before the job is executed. Specific examples of the lack condition can include, for example, such a condition as follows under a condition where N and M are natural numbers.

The lack condition: that N pieces or more of lacks are consecutively present in the inkjet head; or that M pieces or more of lacks are present in the inkjet head.

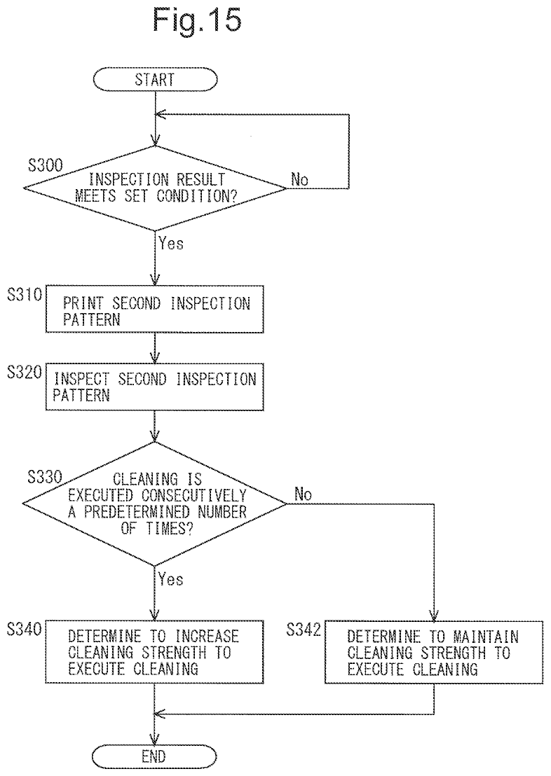

Referring to FIG. 15, a description will be given of a procedure of the processing related to the control of the maintenance in the present modified example. Note that the procedure to be described herein is merely an example, and the present invention is not limited to this.

During the period while the printing is being executed, it is repeatedly determined whether or not the inspection result meets the already set condition (Step S300). In the present modified example, specifically, the lack monitoring unit 159 determines whether or not the inspection result for the first inspection pattern meets the lack condition already set by the user. When the inspection result does not meet the lack condition, it is not necessary to interrupt the printing, and the processing returns to Step S300. When the inspection result meets the lack condition, it is necessary to interrupt the printing, and the processing proceeds to Step S310.

In Step S310, in a similar way to Step S210 (see FIG. 11) in the above-described second embodiment, printing of the main image is stopped, and the second inspection pattern is printed. In this Step S320, in a similar way to Step S220 (see FIG. 11) in the above-described second embodiment, the image inspection device 300 inspects the print image for the second inspection pattern.

Thereafter, referring to the cleaning history CH, regarding the inkjet head that meets the lack condition, it is determined whether or not the cleaning is executed consecutively a predetermined number of times (Step S330). When it is determined in Step S330 that the cleaning is executed consecutively the predetermined number of times, the processing proceeds to Step S340. Meanwhile, when it is determined in Step S330 that the cleaning is not executed consecutively the predetermined number of times, the processing proceeds to Step S342.

In Step S340, a cleaning strength at the current time is set to a strength higher than a cleaning strength when the cleaning was executed the previous time. In Step S342, a cleaning strength at the current time is set to the same strength as the cleaning strength when the cleaning was executed the previous time. Note that the cleaning strength when the cleaning was executed the previous time can be grasped by referring to the above-mentioned cleaning history CH. The configuration may be such that, in Step S340 and Step S342, the cleaning strength is also adjusted on the basis of information of the inkjet head determined in Step S300 to meet the lack condition and on the basis of the inspection result for the second inspection pattern. For example, when the inspection result for the second inspection pattern also indicates that the lack is present regarding the inkjet head determined in Step S300 to meet the lack condition, the cleaning strength of this inkjet head may be increased.

In the present modified example, the processing in Step S330, Step S340 and Step S342 corresponds to the maintenance content determination processing. That is, in the maintenance content determination processing in the present modified example, the cleaning strength is only determined on the basis of the cleaning history CH, and the type of the maintenance is not determined. In the present modified example, when the printing is interrupted, not the flushing of the printing unit 24 but the cleaning of the printing unit 24 is executed irrespective of the inspection result for the first inspection pattern.

### 3. Others

The present invention is not limited to each of the above-described embodiments (including the modified example), and is modifiable variously within the scope without departing from the spirit of the present invention. For example, in each of the above-described embodiments (including the modified example), both of the cleaning and the flushing are not performed between the processing for the preceding job and the processing for the subsequent job. However, depending on the case, both of the cleaning and the flushing may be performed between the processing for the preceding job and the processing for the subsequent job.

In the above-described second embodiment and the above-described modified example, the second inspection pattern is printed after the interruption and stop of the printing of the main image, the printed second inspection pattern is inspected, and the maintenance content is determined on the basis of the results of such inspections. However, in some cases, the second inspection pattern cannot be printed when the printing is interrupted and stopped depending on an occurrence situation of a cause of the interruption and stop of the printing of the main image. Moreover, in other cases, depending on how to construct the printing program of the printing apparatus, the progress of the job is advanced while printing the inspection pattern during the execution of the job. Accordingly, when the second inspection pattern cannot be printed when the printing of the main image is interrupted and stopped, the maintenance content of the present invention may be determined on the basis of the inspection result of the first inspection pattern printed on the print medium PA before the main image is printed. Further, when the progress of the job is advanced while printing the inspection pattern during the execution of the job, the maintenance content of the present invention may be determined on the basis of an inspection result for an inspection pattern printed in a period closes to the time when the printing of the main image is interrupted or the time when the printing is stopped. In such a manner, even if the second inspection pattern cannot be printed when the printing of the main image is interrupted and stopped, an optimum maintenance can be appropriately implemented.

This application is an application claiming priority based on Japanese Patent Application No. 2021-049700 entitled “PRINTING APPARATUS AND MAINTENANCE METHOD THEREOF” filed on Mar. 24, 2021, and the contents of which are herein incorporated by reference.

What is claimed is:

1. A printing apparatus comprising:
a conveying mechanism configured to convey a print medium;
a printing unit composed of a plurality of print heads configured to perform printing on the print medium by ejecting ink;
a cleaning mechanism configured to clean the printing unit;
an inspection device configured to inspect a print image obtained by printing;
a conveyance control unit configured to control a conveyance speed at which the conveying mechanism conveys the print medium;
a printing control unit configured to control operations of the printing unit and the cleaning mechanism; and
a maintenance content determination unit configured to determine a maintenance content for the printing unit, wherein
the conveyance control unit accelerates the print medium until the conveyance speed changes from 0 to a predetermined reference speed before printing based on each job is started, conveys the print medium so that the conveyance speed of the print medium is kept at a constant speed including the reference speed at least in a period during which the printing based on each job is being executed, and decelerates the print medium until the conveyance speed changes from the constant speed to 0 after the printing based on each job is ended,
the printing control unit controls an operation of the printing unit so that an inspection pattern is printed on the print medium in a period during which the conveyance speed is being kept at the constant speed,
the maintenance content determination unit determines the maintenance content for the printing unit based on an inspection result obtained by inspecting the print image for the inspection pattern by the inspection device, and
the printing control unit controls the operations of the printing unit and the cleaning mechanism in accordance with the maintenance content determined by the maintenance content determination unit.

2. The printing apparatus according to claim 1, wherein the maintenance content determination unit further determines whether or not it is necessary to execute the maintenance for the printing unit.

3. The printing apparatus according to claim 1, wherein
cleaning and flushing are prepared as the content of the maintenance for the printing unit, and
the printing control unit controls the operations of the printing unit and the cleaning mechanism so that the cleaning of the printing unit is performed if the maintenance content determined by the maintenance content determination unit is the cleaning, and the printing control unit controls the operation of the printing unit so that the flushing of the printing unit is performed if the maintenance content determined by the maintenance content determination unit is the flushing.

4. The printing apparatus according to claim 3, wherein, when the maintenance content determined by the maintenance content determination unit is the flushing, and lacks are detected consecutively a predetermined number of times for a same print head based on the inspection result obtained by the inspection device, the maintenance content determination unit includes, in the maintenance content for the printing unit, a content to increase a flushing amount at a time of executing the flushing more than a flushing amount at a time of executing the flushing a previous time.

5. The printing apparatus according to claim 3, wherein, when the maintenance content determined by the maintenance content determination unit is the flushing, and lacks are detected consecutively a predetermined number of times for a same print head based on the inspection result obtained by the inspection device, the maintenance content determination unit includes, in the maintenance content for the printing unit, a content to increase a number of flushing sheets at a time of executing the flushing more than a number of flushing sheets at a time of executing the flushing a previous time.

6. The printing apparatus according to claim 3, wherein, when the maintenance content determined by the maintenance content determination unit is the cleaning, the printing control unit controls the operations of the printing unit and the cleaning mechanism so that the cleaning of the printing unit is performed in a period during which the conveyance control unit is keeping the conveyance speed at 0.

7. The printing apparatus according to claim 3, wherein, when the maintenance content determined by the maintenance content determination unit is the flushing, the printing control unit controls the operation of the printing unit so that the flushing of the printing unit is performed in a period during which the conveyance control unit is accelerating the print medium.

8. The printing apparatus according to claim 1, wherein the maintenance content determination unit determines the maintenance content for the printing unit after the printing based on each job is ended.

9. The printing apparatus according to claim 1, wherein
the printing control unit controls the operation of the printing unit so that a first inspection pattern and a second inspection pattern are printed as the inspection pattern in a period during which the conveyance speed is being kept at the constant speed,
the first inspection pattern is printed before printing of a main image based on a processing target job is performed, and
the second inspection pattern is printed after the printing of the main image based on the processing target job is performed, after the printing of the main image is interrupted, or after the printing of the main image is stopped.

10. The printing apparatus according to claim 9, wherein the maintenance content determination unit determines the maintenance content for the printing unit based on the inspection result obtained by inspecting the print image for the second inspection pattern by the inspection device.

11. The printing apparatus according to claim 1, further comprising a monitoring unit configured to detect an event by which the printing should be interrupted, wherein the maintenance content determination unit determines the maintenance content for the printing unit after an event by which the printing should be interrupted is detected by the monitoring unit.

12. The printing apparatus according to claim 11, wherein
the printing control unit controls the operation of the printing unit so that a first inspection pattern and a second inspection pattern are printed as the inspection pattern in a period during which the conveyance speed is being kept at the constant speed,
the first inspection pattern is printed before printing of a main image based on a processing target job is performed,
the second inspection pattern is printed after the printing of the main image based on the processing target job is performed,
when an event by which the printing should be interrupted is detected by the monitoring unit, the printing control unit controls the operation of the printing unit so that the second inspection pattern is printed after a sheet that is being printed, and
the maintenance content determination unit determines the maintenance content for the printing unit based on the inspection result obtained by inspecting the print image for the second inspection pattern by the inspection device.

13. The printing apparatus according to claim 12, wherein the maintenance content determination unit determines the maintenance content for the printing unit after the inspection result obtained by inspecting the print image for the first inspection pattern by the inspection device is detected, by the monitoring unit, as an event by which the printing should be interrupted.

14. The printing apparatus according to claim 11, further comprising a print medium supply unit configured to supply the print medium to the printing unit, wherein
the monitoring unit detects, as the event by which the printing should be interrupted, an event in which an amount of the print medium remaining in the print medium supply unit is reduced to a predetermined value or less.

15. A maintenance method of a printing apparatus including: a printing unit composed of a plurality of print heads configured to perform printing on a print medium by ejecting ink; and a cleaning mechanism configured to clean the printing unit, the maintenance method comprising:
an inspection pattern printing step of causing the printing unit to print an inspection pattern to the print medium in a state in which the print medium is conveyed at a constant speed;
an inspection step of inspecting a print image obtained by printing the inspection pattern;
a maintenance content determination step of determining a maintenance content for the printing unit based on an inspection result obtained by inspecting the print image in the inspection step; and
a maintenance step of controlling operations of the printing unit and the cleaning mechanism depending on the maintenance content determined in the maintenance content determination step.
